(19) United States
(12) Patent Application Publication
(10) Pub. No.: US 2020/0301693 A1
(43) Pub. Date: Sep. 24, 2020

(54) FIRMWARE OVER-THE-AIR ORCHESTRATION FOR IOT DEVICES

(71) Applicant: Verizon Patent and Licensing Inc., Arlington, VA (US)

(72) Inventors: Vikas B. Patel, Parsippany, NJ (US); Robert Stewart, Point Pleasant, NJ (US)

(21) Appl. No.: 16/357,658

(22) Filed: Mar. 19, 2019

(51) Int. Cl. G06F 8/65; H04W 4/80; H04W 76/11

(52) U.S. Cl. CPC G06F 8/65; H04W 84/18; H04W 76/11; H04W 4/80

(57) ABSTRACT

A computer device may include a memory storing instructions and processor configured to execute the instructions to receive a request to perform an Over The Air (OTA) update campaign that includes information identifying user equipment (UE) devices that are to receive a OTA update; identify base stations associated with the UE devices; determine network capacity information for particular ones of the base stations; and generate OTA update batches for the particular ones of the identified base stations based on the determined network capacity information, wherein a particular OTA update batch identifies a subset of UE devices to receive the OTA update before a next OTA update batch. The processor may be further configured to instruct the subset of UE devices to perform the OTA update based on generated OTA update batches.

### BACKGROUND INFORMATION

To satisfy the needs and demands of users of mobile communication devices, providers of wireless communication services continue to improve and expand available services as well as networks used to deliver such services. One aspect of such improvements includes the development of wireless access networks as well as options to utilize such wireless access networks. A wireless access network may manage a large number of devices using different types of services under various types of conditions. Managing a large number of devices may pose various challenges.

### BRIEF DESCRIPTION OF THE DRAWINGS

FIG. 1 is a diagram illustrating an environment according to an implementation described herein;

FIG. 2 is a diagram illustrating exemplary components of a device that may be included in a component of FIG. 1 according to an implementation described herein;

FIG. 3 is a diagram illustrating exemplary components of the Firmware Over-The-Air (FOTA) orchestrator of FIG. 1 according to an implementation described herein;

FIG. 4 is a diagram illustrating exemplary components of the base station database of FIG. 3 according to an implementation described herein;

FIG. 5 is a diagram illustrating exemplary components of the FOTA update campaign database of FIG. 4 according to an implementation described herein;

FIG. 6 is a diagram illustrating exemplary components of the FOTA update batches DB of FIG. 4 according to an implementation described herein;

FIG. 7 is a flowchart of a process for executing a FOTA update campaign according to an implementation described herein;

FIG. 8 is a diagram of an exemplary system according to an implementation described herein;

FIG. 9 is a diagram of an exemplary FOTA update campaign request according to an implementation described herein; and

FIG. 10 is a diagram of an exemplary signal flow according to an implementation described herein.

### DETAILED DESCRIPTION OF PREFERRED EMBODIMENTS

The following detailed description refers to the accompanying drawings. The same reference numbers in different drawings identify the same or similar elements.

While wireless access networks were traditionally designed to support mobile devices, such as smart phones, an increasing number of Internet of Things (IoT) applications have led to a growing number of IoT devices employing machine-to-machine (M2M) communication, such as Machine-Type Communication (MTC). An IoT device may be configured to communicate with other devices without requiring explicit user interaction. IoT devices may have a wide variety of uses, ranging from stationary uses such as utility meters, environmental sensors, parking meters and/or occupancy sensors, security sensors, smart lighting, traffic cameras, advertising displays, point-of-sale terminals, vending machines, remote diagnostics devices, power grid sensors and/or management devices, to high velocity autonomous vehicles and aerial drones.

Uses of IoT devices are envisioned to increase exponentially and may result in a large number of such devices being serviced by a wireless access network. Estimates indicate that the number of IoT devices within a wireless operator's network may increase to hundreds of millions of devices communicating with each other autonomously with little to no human intervention. Thus, a provider of wireless communication services may manage wireless access networks that include a large number of IoT devices.

A wireless network, such as a Fourth Generation (4G) Long Term Evolution (LTE) access network (e.g., an evolved packet core (EPC) network), may use the Evolved Universal Terrestrial Radio Access (E-UTRA) air interface to wirelessly communicate with devices. The bandwidth of an E-UTRA channel in an LTE band may range from about 1.4 to about 20 Megahertz (MHz). In many applications, the data sent or received by IoT devices may be small compared to other types of devices, such as mobile phones used for voice communication or for streaming content. Furthermore, many IoT devices are designed for low power applications and long battery life. Therefore, use of large bandwidth channels that use large amounts of power, such as an LTE channel, for wirelessly communicating with IoT device may be an inefficient use of radio link resources.

A technology developed for IoT applications that does not require large amounts of data and that is based on a Low Power Wide Area Network (LPWAN) design is LTE Category M1 (CAT-M1). CAT-M1 channels, also sometimes referred to as enhanced MTC (eMTC) channels, use a total bandwidth of 1.4 MHz and has a very low power requirement compared to an LTE channel. Another technology, developed for IoT applications, which does not require large amounts of data or power, is the Narrow Band (NB) IoT (NB-IoT) technology. NB-IoT is an LPWAN technology that uses 200 Kilohertz (KHz) channels, with their own guard bands, for sending small amounts of data. The use of NB-IoT channels may result in better signal penetration in hard to reach areas, such as areas likely to be occupied by IoT devices (e.g., a utility meter installed in a location that shadows or fades wireless signals). Furthermore, the use of NB-IoT channels may result in lower energy consumption and/or cheaper component cost.

However, sometimes, a large number of IoT devices on the same network, or even attached to the same base station, may need to receive a large amount of data within a short time period. For example, an entity managing a group of IoT device may need to perform a wireless update, also referred to as an Over-The-Air (OTA) update. One particular type of OTA update that may include the transfer of a large file may be a Firmware OTA (FOTA) update. Other types of OTA updates that may include the transfer of a large file may be a baseband OTA update or an application software OTA update. The firmware of an IoT device may control the low-level operation of the hardware of an IoT device and may need to be periodically upgraded. There may be a limit to the number of simultaneous successful attachments of CAT-M1 and/or NB-IoT devices to a particular base station, or to the number of simultaneous downloads of a FOTA update file via the particular base station. Thus, when an original equipment manufacturer (OEM), or another type of entity managing a large group of IoT devices, decides to add a new functionality to, or fix a potential security flaw in, the large group of IoT devices, the resources of a base station may be overwhelmed.

Implementations described herein relate to OTA orchestration for IoT devices, such as CAT-M1 devices and/or NB-IoT devices. A FOTA orchestrator device may be configured to provide a real-time and/or scheduled service to create orchestrated FOTA updates, and/or other types of OTA updates that may include a large file transfer, to a large number of IoT devices simultaneously without overwhelming the resources of a base station to which the IoT devices are attached. The FOTA orchestrator may be configured to receive a request to perform a FOTA update campaign that includes information identifying a set of UE devices that are to receive the FOTA update; identify one or more base stations associated with the set of UE devices; determine network capacity information for the identified one or more base stations; and generate FOTA update batches for each of the identified one or more base stations based on the determined network capacity information. Each generated FOTA update batch may identify a subset of the UE devices to receive the FOTA update before the next FOTA update batch. The FOTA orchestrator device may then instruct each of the identified base stations to perform the FOTA update based on the generated FOTA update batches.

The network capacity information for a particular base station may identify a number of FOTA updates that the particular base station is configured to handle during a particular time period and each FOTA update batch, associated with the particular base station, may identify a number of UE devices, which are equal to or less than the number of FOTA updates the particular base station is configured to handle, that are to receive the FOTA update before a next FOTA update batch is initiated. Additionally, or alternatively, the network capacity information may identify a number of OTA updates of another type that the particular base station is configured to handle during the particular time period, such as baseband OTA update and/or application software updates, and/or the number of OTA updates for a particular file size that the particular base station is configured to handle during the particular time period.

In some implementations, generating the FOTA update batches may include determining timestamps for attaching to the one or more base stations for particular UE devices and prioritizing the particular UE devices based on the determined timestamps. In some implementations, generating the FOTA update batches may include determining a file size associated with the FOTA update and determining a batch size for the FOTA update batches based on the determined file size.

In some implementations, instructing each of the identified UE devices to perform the FOTA update may include instructing a first set of UE devices in a first FOTA update batch to perform the FOTA update, waiting a particular time period, and instructing a second set of UE devices in a second FOTA update batch to perform the FOTA update.

In other implementations, instructing each of the identified UE devices to perform the FOTA update based on the generated FOTA update batches may include: instructing a first set of UE devices for a first FOTA update batch to perform the FOTA update; receiving an indication from each of the first set of UE devices that the FOTA update was performed successfully; and instructing a second set of UE devices for a second FOTA update batch to perform the FOTA update, in response to receiving the indication from each of the first set of UE devices that the FOTA update was performed successfully. In some implementations, instructing a set of UE devices for a FOTA update batch may include instructing the set of UE devices to perform the FOTA update via a multicast message.

The FOTA orchestrator may maintain a database of base station and IoT UE devices. When a new IoT UE device attaches to a base station, the FOTA orchestrator may receive an indication from the base station that a new IoT UE device has attached to the base station and register the new UE device with the database.

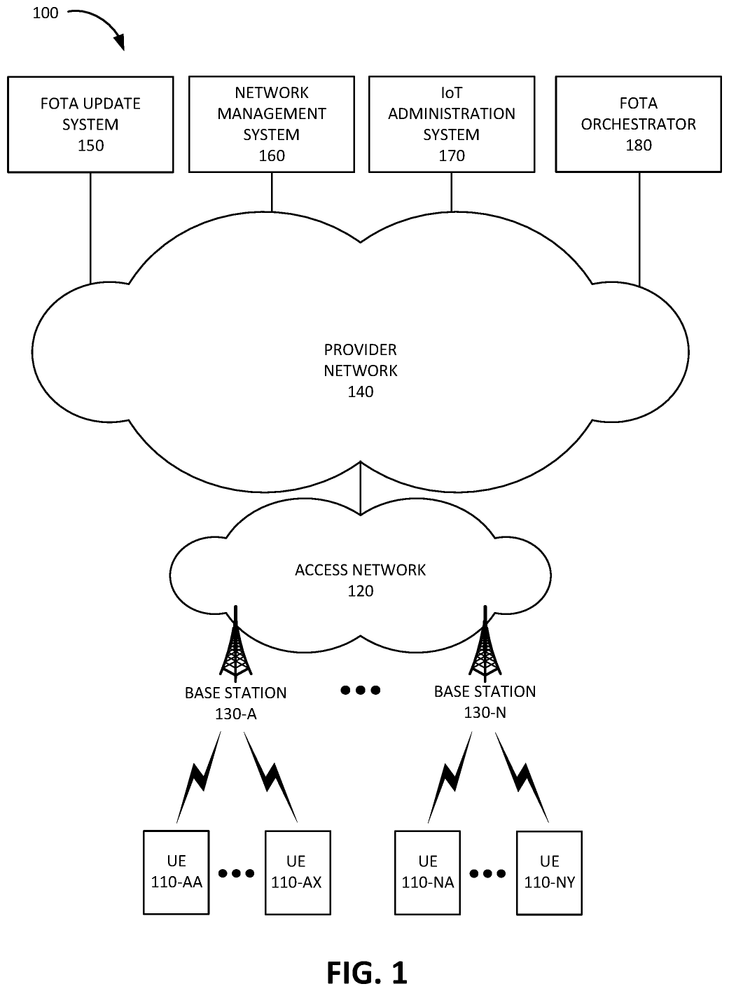

FIG. 1 illustrates an exemplary environment 100 in which the systems and/or methods, described herein, may be implemented. As shown in FIG. 1, environment 100 may include user equipment (UE) devices 110-AA to 110-NY (referred to herein collectively as “UE devices 110” and individually as “UE device 110”), an access network 120, a provider network 140, a FOTA update system 150, a network management system 160, an IoT administration system 170, and a FOTA orchestrator 180.

UE device 110 may include any device with long-range (e.g., cellular or mobile wireless network) wireless communication functionality. For example, UE device 110 may communicate using M2M communication, such as MTC. For example, UE device 110 may include a utility meter (e.g., electricity meter, water meter, gas meter, etc.), an asset tracking device (e.g., a system monitoring the geographic location of a fleet of vehicles, etc.), a traffic management device (e.g., a traffic light, traffic camera, road sensor, road illumination light, etc.), a climate controlling device (e.g., a thermostat, a ventilation system, etc.), a device controlling an electronic sign (e.g., an electronic billboard, etc.), a device controlling a manufacturing system (e.g., a robot arm, an assembly line, etc.), a device controlling a security system (e.g., a camera, a motion sensor, a window sensor, etc.), a device controlling a power system (e.g., a smart grid monitoring device, a utility meter, a fault diagnostics device, etc.), a device controlling a financial transaction system (e.g., a point-of-sale terminal, a vending machine, a parking meter, etc.), health monitoring device (e.g., a blood pressure monitoring device, a blood glucose monitoring device, etc.), and/or another type of electronic device.

In other implementations, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer; a customer premises equipment (CPE) device, such as a set-top box or a digital media player (e.g., Apple TV, Google Chromecast, Amazon Fire TV, etc.), a WiFi access point, a smart television, etc.; a portable gaming system; a global positioning system (GPS) device; a home appliance device; a home monitoring device; and/or any other type of computer device with wireless communication capabilities and/or a user interface.

Access network 120 may provide access to provider network 140 for UE devices 110. Access network 120 may enable UE device 110 to connect to provider network 140 for mobile telephone service, Short Message Service (SMS) message service, Multimedia Message Service (MMS) message service, Internet access, cloud computing, and/or other types of data services.

Access network 120 may establish a packet data network connection between UE device 110 and provider network 140 via one or more Access Points (APs). For example, access network 120 may establish an Internet Protocol (IP) connection between UE device 110 and provider network 140. Furthermore, access network 120 may enable UE device 110 to communicate with an application server, and/or another type of device, located in provider network 140 using a communication method that does not require the establishment of an IP connection between UE device 110 and provider network 140 through a gateway, such as, for example, Data over Non-Access Stratum (DoNAS) communication method.

In some implementations, access network 120 may include a Long-Term Evolution (LTE) access network. In other implementations, access network 120 may include a Code Division Multiple Access (CDMA) access network. For example, the CDMA access network may include a CDMA enhanced High Rate Packet Data (eHRPD) access network (which may provide access to an LTE access network).

Furthermore, access network 120 may include an LTE Advanced (LTE-A) access network and/or a 5G access network or other advanced access network that includes functionality such as 5G New Radio (NR) base stations; carrier aggregation; advanced or massive multiple-input and multiple-output (MIMO) configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as CAT-M1 and/or NB-IoT technology, and/or other types of MTC technology; and/or other types of LTE-A and/or 5G functionality.

As described herein, access network 120 may include base stations 130-A to 130-N (referred to herein collectively as “base stations 130” and individually as “base station 130”). Each base station 130 may service a set of UE devices 110. For example, base station 130-A may service UE devices 110-AA to 110-AX, etc., and base station 130-N may service UE devices 110-NA to 110-NY. In other words, UE devices 110-AA to 110-AX may be located within the geographic area serviced by base station 130-A, and other UE devices 110 NA to NY may be serviced by another base station 130-N. Base station 130 may include a 4G LTE base station (e.g., an eNodeB) and/or a Fifth Generation (5G) New Radio (NR) base station (e.g., a gNodeB). Base station 130 may include one or more RF transceivers (also referred to as “cells” and/or “base station sectors”) facing particular directions. For example, base station 130 may include three RF transceivers and each RF transceiver may service a 120° sector of a 360° field of view.

Access network 120 may include LTE EPC network elements, such as a Mobility Management Entity (MME), a Serving Gateway (SGW), a Packet Data Network Gateway (PGW), a Home Subscriber Server (HSS), a Policy and Charging Rules Function (PCRF), and/or other EPC network elements. In other implementations, access network 120 may include a 5G Standalone (SA) architecture that includes 5G network functions such as an Access and Mobility Function (AMF), a User Plane Function (UPF), a Session Management Function (SMF), an Application Function (AF), a Unified Data Management (UDM), a Policy Control Function (PCF), a Network Repository Function (NRF), a Network Exposure Function (NEF), a Network Slice Selection Function (NSSF), and/or other 5G SA network elements. Furthermore, the 5G SA network may be configured to implement network slicing.

Provider network 140 may include, and/or be connected to and enable communication with, a local area network (LAN), a wide area network (WAN), a metropolitan area network (MAN), an optical network, a cable television network, a satellite network, a wireless network (e.g., a CDMA network, a general packet radio service (GPRS) network, and/or an LTE network), an ad hoc network, a telephone network (e.g., the Public Switched Telephone Network (PSTN) or a cellular network), an intranet, or a combination of networks. Some or all of provider network 140 may be managed by a provider of communication services that also manages access network 120 and/or UE device 110. Provider network 140 may allow the delivery of Internet Protocol (IP) services to UE device 110, and may interface with other external networks. Provider network 140 may include one or more server devices and/or network devices, or other types of computation or communication devices. In some implementations, provider network 140 may include an IP Multimedia Sub-system (IMS) network (not shown in FIG. 1). An IMS network may include a network for delivering IP multimedia services and may provide media flows between UE device 110 and external IP networks or external circuit-switched networks (not shown in FIG. 1).

FOTA update system 150 may include one or more computer devices, such as server devices, which are configured to provide FOTA updates, and/or other types of updates to IoT devices, such as UE devices 110. For example, FOTA update system 150 may receive an update (e.g., one or more update files) from IoT administration system 170 and may provide the update to UE device 110 in response to UE device 110 sending a message to FOTA update system 150 requesting the update.

Network management system 160 may include one or more computer devices, such as server devices, which are configured to manage access network 120 and/or provider network 140. For example, network management system 160 may maintain information relating to the network capacity associated with particular base stations 130, such as the number of FOTA updates a particular base station 130 is able to handle at a particular time.

IoT administration system 170 may include one or more computer devices, such as server devices, which are configured to manage a set of IoT devices. For example, IoT administration system 170 may generate a FOTA update campaign for a set of IoT UE devices 110. IoT administration system 170 may provide one or more update files to FOTA update system 150 and may provide information relating to the FOTA update campaign to FOTA orchestrator 180. The FOTA update campaign information may include information identifying the file size associated with the FOTA update and information identifying the UE devices 110 that are to receive the FOTA update.

FOTA orchestrator 180 may include one or more computer devices, such as server devices, which are configured to orchestrate a FOTA update associated with a FOTA update campaign, and/or another type of OTA update associated with a large file (e.g., a file larger than a threshold). For example, FOTA orchestrator 180 may receive a request to perform a FOTA update campaign from IoT administration system 170, may receive network capacity information relating to base stations 130 from network management system 160, and may orchestrate a FOTA update campaign based on the received request and the received network capacity information.

Although FIG. 1 shows exemplary components of environment 100, in other implementations, environment 100 may include fewer components, different components, differently arranged components, or additional functional components than depicted in FIG. 1. Additionally, or alternatively, one or more components of environment 100 may perform functions described as being performed by one or more other components of environment 100.

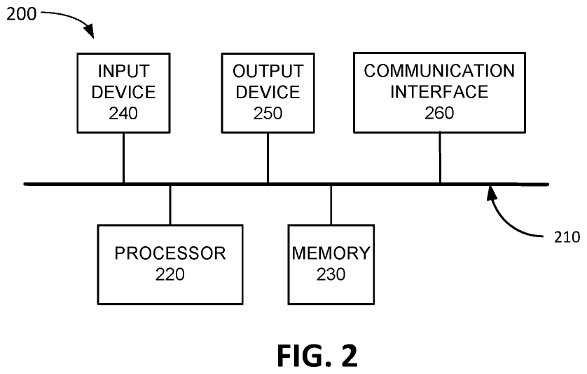

FIG. 2 is a diagram illustrating example components of a device 200 according to an implementation described herein. UE device 110, base station 130, FOTA update system 150, network management system 160, IoT administration system 170, and FOTA orchestrator 180 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, output device 250 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to one or more antennas/antenna arrays for transmitting and receiving RF signals.

Communication interface 260 may include input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio frequency identification (RFID) interface, a near-field communications (NFC) wireless interface, and/or any other type of interface that converts data from one form to another form.

As will be described in detail below, device 200 may perform certain operations relating to orchestrating a FOTA update campaign. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

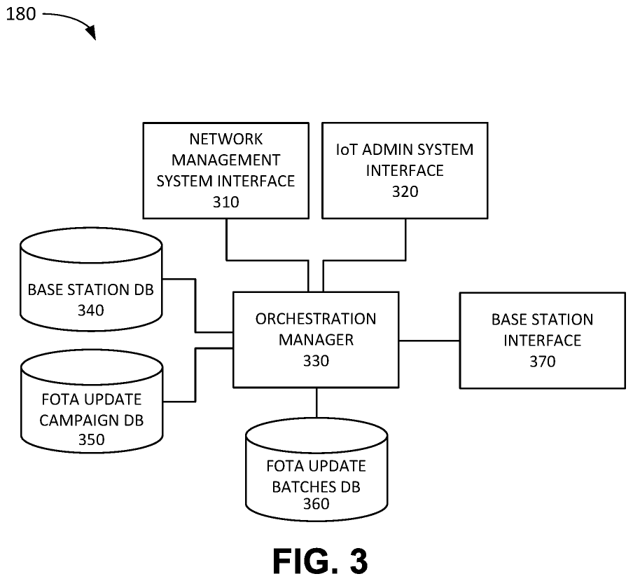

FIG. 3 is a diagram illustrating exemplary components of FOTA orchestrator 180. The components of FOTA orchestrator 180 may be implemented, for example, via processor 220 executing instructions from memory 230. Alternatively, some or all of the functional components of FOTA orchestrator 180 may be implemented via hard-wired circuitry. As shown in FIG. 3, FOTA orchestrator 180 may include a network management system interface 310, an IoT administration (admin) system interface 320, an orchestrator manager 330, a base station database (DB) 340, a FOTA update campaign DB 350, a FOTA update batches DB 360, and a base station interface 370.

Network management system interface 310 may be configured to communicate with network management system 160. For example, network management system interface 310 may receive information relating to network capacity of base stations 130 from network management system 160. IoT administration system interface 320 may be configured to communicate with IoT administration system 170. For example, IoT administration system interface 320 may receive information relating to a FOTA update campaign from IoT administration system 170.

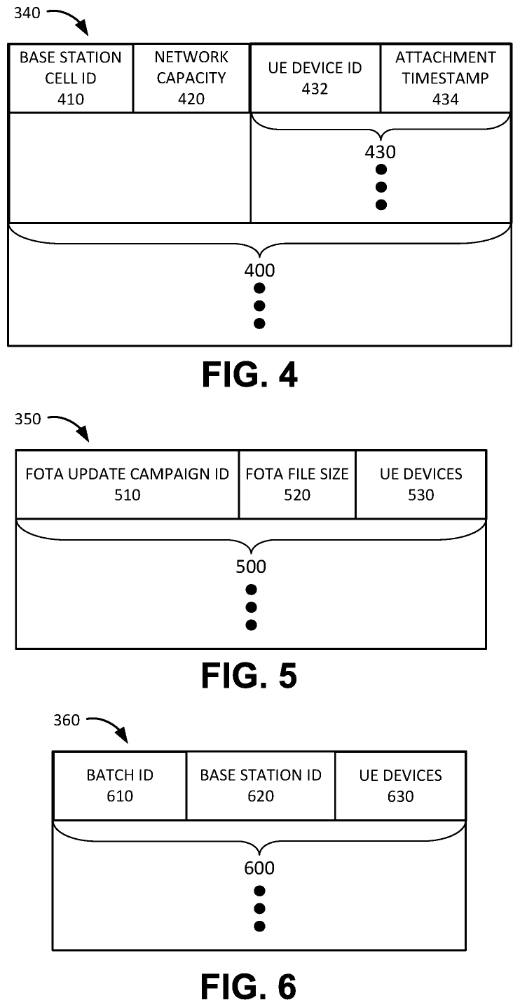

Orchestrator manager 330 may orchestrate a FOTA update campaign based on information stored in base station DB 340 and FOTA update campaign DB 350, may orchestrate FOTA campaign batches based on the information, and may store information relating to the orchestrated FOTA update campaign batches in FOTA update batches DB 360. Base station DB 340 may store information relating to base stations 130. Exemplary information that may be stored in base station DB 340 is described below with reference to FIG. 4. FOTA update campaign DB 350 may store information relating to FOTA update campaigns. Exemplary information that may be stored in FOTA update campaign DB 350 is described below with reference to FIG. 5. FOTA update batches DB 360 may store information relating to FOTA update batches generated by orchestrator manager 330. Exemplary information that may be stored in FOTA update campaign DB 350 is described below with reference to FIG. 6.

Base station interface 370 may be configured to communicate with base stations 130. For example, orchestrator manager 330 may use base station interface 370 to send instructions to particular UE devices 110, via particular base stations 130, to request a FOTA update from FOTA update system 150. Orchestrator manager 330 may further receive, via base station interface 370, messages from particular UE devices 110 indicating that a FOTA update was performed successfully.

Although FIG. 3 shows exemplary components of FOTA orchestrator 180, in other implementations, FOTA orchestrator 180 may include fewer components, different components, differently arranged components, or additional components than depicted in FIG. 3. Additionally, or alternatively, one or more components of FOTA orchestrator 180 may perform functions described as being performed by one or more other components of FOTA orchestrator 180.

FIG. 4 illustrates exemplary information stored in base station DB 340 according to an implementation described herein. As shown in FIG. 4, base station DB 340 may include one or more base station records 400. Each base station record 400 may store information relating to a particular base station cell or sector. Base station record 400 may include a base station identifier (ID) field 410, a network capacity field 420, and one or more UE device records 430.

Base station ID field 410 may store an ID associated with a particular base station 130. Network capacity field 420 may store information identifying a network capacity associated with the particular base station 130. As an example, network capacity field 420 may store information indicating the number of simultaneous CAT-M1 and/or NB-IoT attachments that the particular base station 130 is able to handle. As another example, network capacity field 420 may store information indicating the number of OTA updates, such as FOTA updates, baseband OTA updates, and/or application software OTA updates, that the particular base station 130 is able to handle within a particular time period. As yet another example, network capacity field 420 may store information indicating the number of OTA updates involving a particular file size (e.g., over 1 Megabyte, etc.) that the particular base station 130 is able to handle within the particular time period. As yet another example, network capacity field 420 may indicate the throughput that the particular base station 130 is able to handle for CAT-M1 and/or NB-IoT UE devices 110 within a particular time period.

Each UE device record 430 may store information relating to a particular UE device 110 that is attached to the particular base station 130. UE device record 430 may include a UE device ID field 432 and an attachment timestamp 434. UE device ID field 432 may store one or more IDs associated with a particular UE device 110 attached to base station 130. For example, UE device ID field 432 may store an International Mobile Equipment Identity (IMEI) ID, an Electronic Serial Number (ESN) ID, an International Mobile Subscriber Identity (IMSI) ID, a Mobile Directory Number (MDN) ID, a Mobile Station International Subscriber Directory Number (MSISDN) ID, a Globally Unique Temporary Identity (GUTI) ID, a Cell Radio Network Temporary Identity (CRTNI) ID, an IP address, a Media Access Control (MAC) address, and/or another type of identifier associated with the particular UE device 110. Attachment timestamp field 434 may store an attachment timestamp, for the particular UE device 110 that indicates when the particular UE device 110 has attached to the particular base station 130. UE device records 430 may be updated when a new UE device 110 attaches to the particular base station 130. For example, FOTA orchestrator 180 may receive an indication from the particular base station 130 that a new UE device 110 has attached and may, in response, register the new UE device 110 in base station DB 340 by generating a new UE device record 430.

Although FIG. 4 shows exemplary components of base station DB 340, in other implementations, base station DB 340 may include fewer components, different components, additional components, or differently arranged components than depicted in FIG. 4.

FIG. 5 is a diagram illustrating exemplary components stored in FOTA update campaign DB 350 according to an implementation described herein. As shown in FIG. 5, update campaign DB 350 may include a FOTA update campaign ID field 510, a FOTA file size field 520, and a UE devices field 530. FOTA update campaign ID field 510 may store an ID associated with a particular FOTA update campaign requested by IoT administration system 170. FOTA file size field 520 may store information indicating the size of a file for a FOTA update associated with the particular FOTA update campaign. UE devices field 530 may store information identifying a set of UE devices 110 for which the FOTA update, associated with the particular FOTA update campaign, is to be performed. For example, UE devices field 530 may store a particular type of UE device ID that is stored in base station DB 340, as described above with reference to FIG. 4.

Although FIG. 5 shows exemplary components of FOTA update campaign DB 350, in other implementations, FOTA update campaign DB 350 may include fewer components, different components, additional components, or differently arranged components than depicted in FIG. 5.

FIG. 6 is a diagram illustrating exemplary components of the FOTA update batches DB 360 according to an implementation described herein. As shown in FIG. 6, FOTA update batches DB 360 may store a batch ID field 610, a base station ID field 620, and a UE devices field 630. Batch ID field 610 may store an ID associated with a particular FOTA update batch. Base station ID field 620 may store a base station ID associated with a particular base station 130 associated with the particular FOTA update batch. UE devices field 630 may store information identifying UE devices 110 associated with the particular FOTA update batch. For example, UE devices field 630 may store a particular type of UE device ID that stored in base station DB 340 as described above with reference to FIG. 4.

Although FIG. 6 shows exemplary components of FOTA update batches DB 360, in other implementations, FOTA update batches DB 360 may include fewer components, different components, additional components, or differently arranged components than depicted in FIG. 6.

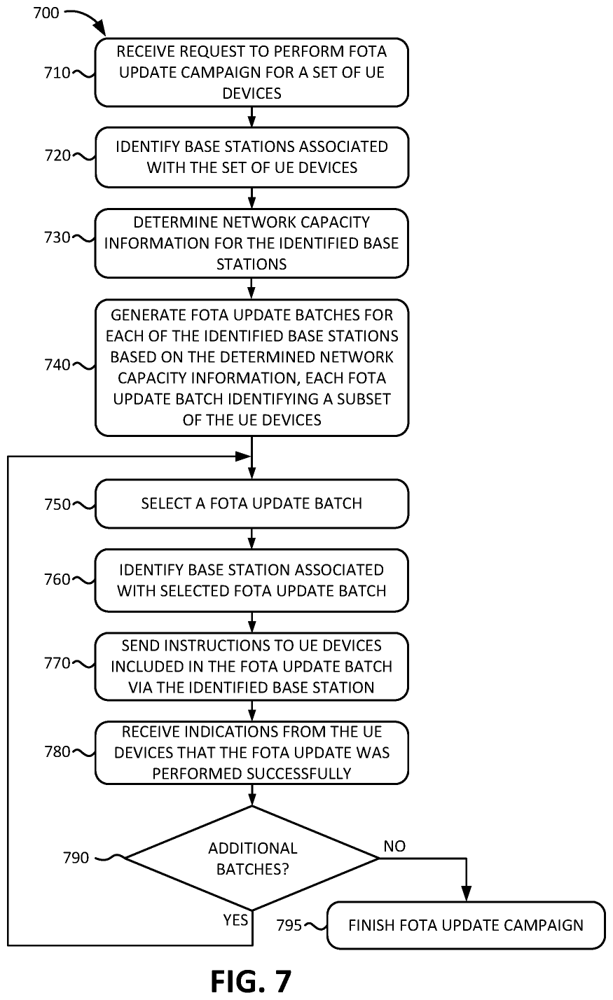

FIG. 7 is a flowchart of a process for executing a FOTA update campaign according to an implementation described herein. In some implementations, the process of FIG. 7 may be performed by FOTA orchestrator 180. In other implementations, some or all of the process of FIG. 7 may be performed by another device or a group of devices separate from FOTA orchestrator 180.

The process of flowchart 700 may include receiving a request to perform a FOTA update campaign for a set of UE devices (block 710). For example, FOTA orchestrator may receive a FOTA update campaign request from IoT administration device 170 for a particular FOTA update. The FOTA update campaign request may include information indicating a file size associated with the particular FOTA update and a list of IDs for UE devices 110 for which the particular FOTA update is to be performed.

Base stations associated with the set of UE devices may be identified (block 720) and network capacity information for the identified base stations may be determined (block 730). For example, FOTA orchestrator 180 may identify, for each particular UE device 110 identified in the FOTA update campaign request, a base station 130 to which the particular UE device 110 is attached. For each of the identified base stations 130, FOTA orchestrator 180 may determine how many FOTA updates the particular base station 130 is able to handle at a time or within a particular time period.

FOTA update batches for each of the identified base stations may be generated based on the determined network capacity information, with each FOTA update batch including a list of a subset of UE devices from the set of UE devices (block 740). For example, for each identified base station 130, FOTA orchestrator 180 may generate FOTA update batches. Each FOTA update batch may identify a subset of UE devices 110 identified in the FOTA update campaign request and attached to the particular base station 130, such that the number of UE devices 110 in the subset does not exceed the number of FOTA updates that the particular base station 130 is able to handle.

A FOTA update batch may be selected (block 750), a base station associated with the selected FOTA update batch may be identified (block 760), and instructions may be sent to the UE devices included in the selected FOTA update batch (block 770). For example, FOTA orchestrator 180 may send, via the associated base station 130, an instruction to each UE device 110 identified in the selected batch to request a FOTA update from FOTA update system 150. FOTA orchestrator 180 may sequence through the list of identified base stations 130 when processing batches. For example, FOTA orchestrator 180 may instruct UE devices 110 associated with a first batch for a first base station 130, instruct UE devices 110 associated with a first batch for a second base station 130, etc., until the first batches for each identified base station 130 are processed. FOTA orchestrator 180 may then process the second batches for each identified base station 130, etc. In some implementations, the instructions may be sent to each individual UE device 110 in the selected batch via unicast. In other implementations, a multicast message may be sent to the UE devices 110 in the selected batch.

In some implementations, a new batch may be selected after a particular time period has elapsed. In other implementations, a new batch may be selected after UE devices 110 in the selected batch indicate that the FOTA update was performed successfully. Thus, indications may be received from the UE devices that the FOTA update was performed successfully (block 780). For example, UE device 110 may send an indication to FOTA orchestrator 180 that the FOTA update was successfully received from FOTA update system 150. If a particular UE device 110 fails to receive the FOTA update, the particular UE device 110 may be given a designated length of time during which to retry the request. If the particular UE device 110 is not able to receive the FOTA update within the designated length of time, the particular UE device 110 may be placed on a failure list. After all batches have been processed, FOTA orchestrator 180 may re-send the instruction to any UE devices 110 included in the failure list.

A determination may be made whether there are additional batches (block 790). For example, FOTA orchestrator 180 may check FOTA update batches DB 360 to determine whether there are additional FOTA update batches that have not been processed. If it is determined that there are additional batches (block 790-YES), processing may return to block 750 to select another batch. If it is determined that there are no additional batches (block 790-NO), the FOTA update campaign may be designated as being finished (block 795).

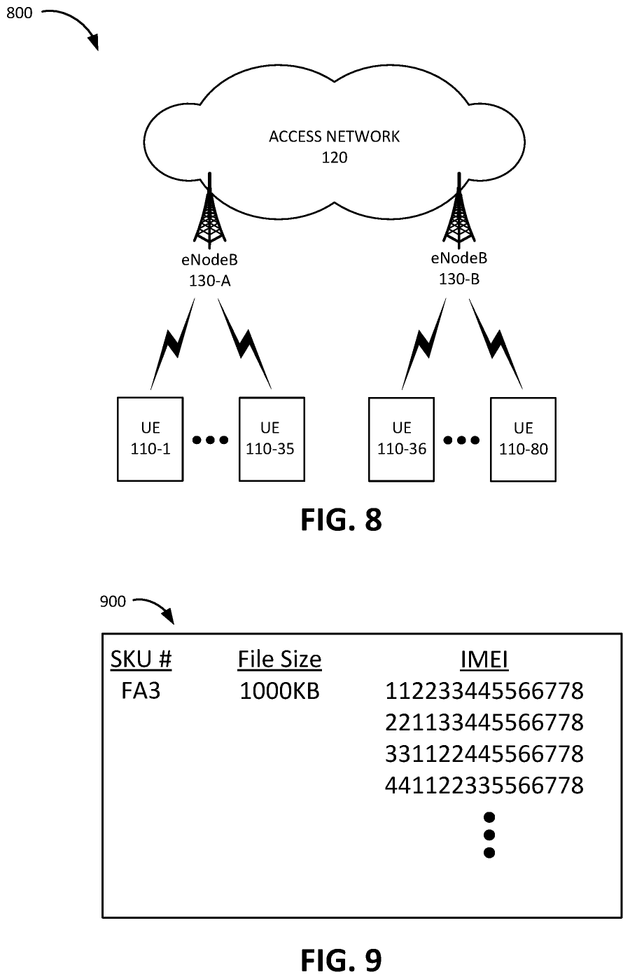

FIG. 8 is a diagram of an exemplary system 800 according to an implementation described herein. As shown in FIG. 8, system 800 may include eNodeB 130-A with 35 attached UE devices 110-1 to 110-35 and eNodeB 130-B with 45 attached UE devices 110-36 to 110-80 devices. Assume UE devices 110-1 to 110-80 are IoT devices managed by IoT administration system 170. FIG. 9 is a diagram of an exemplary FOTA update campaign request 900 that may be generated by IoT administration system 170 for system 800. As shown in FIG. 9, FOTA update campaign request 900 may include a FOTA update campaign stock keeping unit (SKU) ID, a file size indication, and a list of UE devices, identified by an IMEI, for which a FOTA update is to be performed.

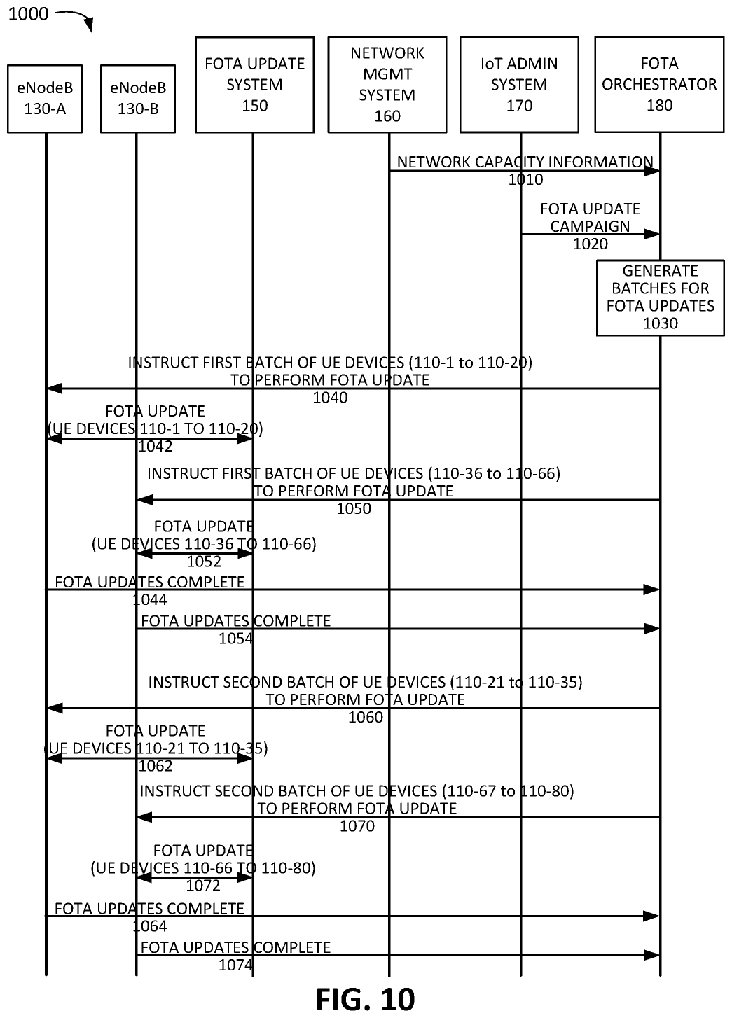

FIG. 10 is a diagram of an exemplary signal flow 1000 for implementing a FOTA update campaign for system 800 based on FOTA update campaign request 900. As shown in FIG. 10, signal flow 1000 may include network management system 160 providing network capacity information for eNodeBs 130-A and 130-B to FOTA orchestrator 180 (signal 1010). Assume the network capacity information indicates that eNodeB 130-A is able to handle 20 FOTA updates within a particular time period (e.g., substantially simultaneously) and that eNodeB 130-B is able to handle 30 FOTA updates within the particular time period.

At a later time, IoT administration system 170 may request a FOTA update campaign for a FOTA update available via FOTA update system 150 (signal 1020). The FOTA update campaign request may designate UE devices 110-1 to 110-80 for receiving the FOTA update. In response, FOTA orchestrator 180 may generate FOTA update batches for UE devices 110-1 to 110-80 based on the network capacity associated with eNodeBs 110-A and 110-B (block 1030). For example, FOTA orchestrator 180 may generate a first batch for eNodeB 110-A that includes UE devices 110-1 to 110-20, a second batch for eNodeB 110-A that includes UE devices 110-21 to 110-35, a first batch for eNodeB 110-B that includes UE devices 110-36 to 110-66, and a second batch for eNodeB 110-B that includes UE devices 110-67 to 110-80.

FOTA orchestrator 180 may then send messages to UE devices 110-1 to 110-20 via eNodeB 130-A to request the FOTA update (signals 1040). In response, UE devices 110-1 to 110-20 may individually request and receive the FOTA update from FOTA update system 150 via eNodeB 130-A (signals 1042). UE devices 110-1 to 110-20 may then individually inform FOTA orchestrator 180 that the FOTA update was successfully received (signals 1044).

FOTA orchestrator 180 may also send messages to UE devices 110-36 to 110-66 via eNodeB 130-B to request the FOTA update (signals 1050). In response, UE devices 110-36 to 110-66 may individually request and receive the FOTA update from FOTA update system 150 via eNodeB 130-B (signals 1052). UE devices 110-36 to 110-66 may then individually inform FOTA orchestrator 180 that the FOTA update was successfully received (signals 1054).

After the first batch associated with eNodeB 130-A is completed, FOTA orchestrator 180 may then send messages to UE devices 110-21 to 110-35 via eNodeB 130-A to request the FOTA update (signals 1060). In response, UE devices 110-21 to 110-35 may individually request and receive the FOTA update from FOTA update system 150 via eNodeB 130-A (signals 1062). UE devices 110-21 to 110-35 may then individually inform FOTA orchestrator 180 that the FOTA update was successfully received (signals 1064).

Furthermore, after the first batch associated with eNodeB 130-B is completed, FOTA orchestrator 180 may then send messages UE devices 110-67 to 110-80 via eNodeB 130-B to request the FOTA update (signals 1070). In response, UE devices 110-67 to 110-80 may individually request and receive the FOTA update from FOTA update system 150 via eNodeB 130-A (signals 1062). UE devices 110-67 to 110-80 may then individually inform FOTA orchestrator 180 that the FOTA update was successfully received (signals 1074). The FOTA update campaign may then be considered completed.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIG. 7, and a series of signal flows has been described with respect to FIG. 10, the order of the blocks and/or signal flows may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method performed by a computer device, the method comprising:
receiving, by the computer device, a request to perform an Over-The-Air (OTA) update campaign, wherein the request includes information identifying a plurality of user equipment (UE) devices that are to receive a OTA update;
identifying, by the computer device, one or more base stations associated with the plurality of UE devices;
determining, by the computer device, network capacity information for particular ones of the identified one or more base stations;
generating, by the computer device, a plurality of OTA update batches for the particular ones of the identified one or more base stations based on the determined network capacity information, wherein a particular OTA update batch, of the plurality of OTA update batches, identifies a subset of UE devices, from the plurality of UE devices, to receive the OTA update before a next OTA update batch; and
instructing, by the computer device, the subset of UE devices to perform the OTA update based on generated plurality of OTA update batches.

2. The method of claim 1, wherein the OTA update campaign includes a Firmware OTA (FOTA) update campaign and wherein the OTA update includes a FOTA update.

3. The method of claim 1, wherein a number of UE devices in a particular one of the plurality of OTA update batches, for a particular one of the identified one or more base stations, is based on the network capacity information associated with the particular one of the identified one or more base stations, and wherein the network capacity information identifies a number of UE device updates that the particular one of the identified one or more base stations is configured to handle during a particular time period.

4. The method of claim 1, wherein generating the plurality of OTA update batches for the particular ones of the identified one or more base stations based on the determined network capacity information includes:
determining timestamps for attaching to the one or more base stations for particular ones of the plurality of UE devices; and
prioritizing the particular ones of the plurality of UE devices based on the determined timestamps.

5. The method of claim 1, wherein generating the plurality of OTA update batches for the particular ones of the identified one or more base stations based on the determined network capacity information includes:
determining a file size associated with the OTA update; and
determining a batch size for the plurality of OTA update batches based on the determined file size.

6. The method of claim 1, wherein instructing the subset of UE device to perform the OTA update based on generated plurality of OTA update batches includes:
instructing a first set of UE devices in a first batch, of the plurality of OTA update batches, to perform the OTA update;
waiting a particular time period; and
instructing a second set of UE devices in a second batch, of the plurality of OTA update batches, to perform the OTA update.

7. The method of claim 6, wherein instructing the first set of UE devices in the first batch to perform the OTA update further includes:
instructing the first set of UE devices in the first batch to perform the OTA update via a multicast message.

8. The method of claim 1, wherein instructing the subset of UE device to perform the OTA update based on generated plurality of OTA update batches includes:
instructing a first set of UE devices in a first batch, of the plurality of OTA update batches, to perform the OTA update;
receiving an indication from each of the first set of UE devices that the OTA update was performed successfully; and
instructing a second set of UE devices in a second batch, of the plurality of OTA update batches, to perform the OTA update, in response to receiving the indication from each of the first set of UE devices that the OTA update was performed successfully.

9. The method of claim 1, further comprising:
receiving an indication from a base station that a new UE device has attached to the base station; and
registering the new UE device in a database, in response to receiving the indication from the base station that the new UE device has attached to the base station.

10. The method of claim 1, wherein the plurality of UE devices includes:
a Category M (Cat-M) Internet of Things (IoT) device, or
a Narrow Band IoT (NB-IoT) device.

11. A computer device comprising:
a memory storing instructions; and
a processor configured to execute the instructions to:
receive a request to perform an Over-The-Air (OTA) update campaign, wherein the request includes information identifying a plurality of user equipment (UE) devices that are to receive a OTA update;
identify one or more base stations associated with the plurality of UE devices;
determine network capacity information for particular ones of the identified one or more base stations;
generate a plurality of OTA update batches for the particular ones of the identified one or more base stations based on the determined network capacity information, wherein a particular OTA update batch, of the plurality of OTA update batches, identifies a subset of UE devices, from the plurality of UE devices, to receive the OTA update before a next OTA update batch; and
instruct the subset of UE devices to perform the OTA update based on generated plurality of OTA update batches.

12. The computer device of claim 11, wherein the OTA update campaign includes a Firmware OTA (FOTA) update campaign and wherein the OTA update includes a FOTA update.

13. The computer device of claim 11, wherein a number of UE devices in a particular one of the plurality of OTA update batches, for a particular one of the identified one or more base stations, is based on the network capacity information associated with the particular one of the identified one or more base stations, and wherein the network capacity information identifies a number of UE device updates that the particular one of the identified one or more base stations is configured to handle during a particular time period.

14. The computer device of claim 11, wherein, when generating the plurality of OTA update batches for the particular ones of the identified one or more base stations based on the determined network capacity information, the processor is further configured to:
determine timestamps for attaching to the one or more base stations for particular ones of the plurality of UE devices; and
prioritize the particular ones of the plurality of UE devices based on the determined timestamps.

15. The computer device of claim 11, wherein, when generating the plurality of OTA update batches for the particular ones of the identified one or more base stations based on the determined network capacity information, the processor is further configured to:
determine a file size associated with the OTA update; and
determine a batch size for the plurality of OTA update batches based on the determined file size.

16. The computer device of claim 11, wherein, when instructing particular ones of the plurality of UE device to perform the OTA update based on generated plurality of OTA update batches, the processor is further configured to:
instruct a first set of UE devices in a first batch, of the plurality of OTA update batches, to perform the OTA update;
wait a particular time period; and
instruct a second set of UE devices in a second batch, of the plurality of OTA update batches, to perform the OTA update.

17. The computer device of claim 16, wherein, when instructing the first set of UE devices in the first batch to perform the OTA update, the processor is further configured to:
instruct the first set of UE devices in the first batch to perform the OTA update via a multicast message.

18. The computer device of claim 11, wherein, when instructing particular ones of the plurality of UE device to perform the OTA update based on generated plurality of OTA update batches, the processor is further configured to:
instruct a first set of UE devices in a first batch, of the plurality of OTA update batches, to perform the OTA update;
receive an indication from each of the first set of UE devices that the OTA update was performed successfully; and
instruct a second set of UE devices in a second batch, of the plurality of OTA update batches, to perform the OTA update, in response to receiving the indication from each of the first set of UE devices that the OTA update was performed successfully.

19. The computer device of claim 11, wherein the plurality of UE devices includes:
a Category M (Cat-M) Internet of Things (IoT) device, or
a Narrow Band IoT (NB-IoT) device.

20. A non-transitory computer-readable memory device storing instructions executable by a processor, the non-transitory computer-readable memory device comprising:
one or more instructions to receive a request to perform an Over-The-Air (OTA) update campaign, wherein the request includes information identifying a plurality of user equipment (UE) devices that are to receive a OTA update;
one or more instructions to identify one or more base stations associated with the plurality of UE devices;
one or more instructions to determine network capacity information for particular ones of the identified one or more base stations;
one or more instructions to generate a plurality of OTA update batches for the particular ones of the identified one or more base stations based on the determined network capacity information, wherein a particular OTA update batch, of the plurality of OTA update batches, identifies a subset of UE devices, from the plurality of UE devices, to receive the OTA update before a next OTA update batch; and
one or more instructions to instruct the subset of UE devices to perform the OTA update based on generated plurality of OTA update batches.
